(19) United States
(12) Patent Application Publication
(10) Pub. No.: US 2007/0210067 A1
(43) Pub. Date: Sep. 13, 2007

(54) Water Heating Systems and Methods for Detecting Dry Fire Conditions

(76) Inventors: Wade C. Patterson, Huntsville, AL (US); Terry G. Phillips, Meridianville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/677,312

(22) Filed: Feb. 21, 2007

Related U.S. Application Data
(60) Provisional application No. 60/775,078, filed on Feb. 21, 2006.

(51) Int. Cl. H05B 3/02

(52) U.S. Cl. 219/481

(57) ABSTRACT

The present disclosure generally pertains to water heating systems capable of detecting for dry fire conditions. A water heating system In accordance with one exemplary embodiment of the present disclosure comprises a controller that determines at least one ambient condition, such as ambient temperature, and that then checks for a dry fire condition based on the ambient condition. For example, the controller may dynamically determine a sampling interval for a dry fire test based on the ambient condition. In another example, the controller may dynamically determine a threshold used for sensing a dry fire condition based on the ambient condition. Various other parameters used for testing for a dry fire condition may be based on the ambient condition in other examples.

### CROSS REFERENCE TO RELATED APPLICATION

This application claims priority to U.S. Provisional Application No. 60/775,078, entitled “Water Heating System and Method for Detecting Dry Fire Conditions,” and filed on Feb. 21, 2006, which is incorporated herein by reference.

### RELATED ART

Typical water heaters attempt to maintain the temperature of water within a tank within a desired range. To control the water temperature, a controller selectively activates and deactivates one or more heating elements submerged in the water based on one or more temperature sensors located in close proximity of the heating elements. When a heating element is activated, electricity is passed through the heating element to generate heat, which warms the water surrounding the heating element.

One potential problem associated with water heaters having electrical heating elements is the destruction of an element resulting from a dry fire condition. A dry fire condition exists when a heating element is not submerged in water. Such a condition may exist due to improper installation, repair, or operation of the water heater. For example, not realizing that the tank of a water heater is empty, a technician may activate a controller of the water heater before filling the tank with water. If power is applied to a heating element when it is not submerged in water, the heating element can quickly heat to an extremely high temperature resulting in damage to the heating element and/or other components of the water heater.

U.S. Pat. No. 6,649,881 describes exemplary techniques for detecting dry fire conditions and preventing such conditions from damaging components of a water heater. In an embodiment described by U.S. Pat. No. 6,649,881, a heating element is activated for only a short period of time, and temperatures sensed by a temperature sensor in close proximity to the heating element are measured to detect whether a dry fire condition exists. In this regard, a first temperature sensed before or just after activation of the heating element is measured and recorded. Then, a second temperature is measured after a predetermined time interval, such as one minute. If the difference of the two temperatures exceeds a predetermined threshold, then a dry fire condition is detected. In response to such a detection, operation of the heating element is disabled in an effort to prevent damage to the heating element.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary water heating system in accordance with the present disclosure.

FIG. 2 is a block diagram illustrating an exemplary embodiment of a controller, such as is depicted in FIG. 1.

FIG. 3 is a block diagram illustrating an exemplary instruction execution apparatus that may be used in the controller depicted by FIG. 2.

FIG. 4 is a flow chart illustrating an exemplary operation and use of the water heating system depicted by FIG. 1.

FIG. 5 is a block diagram illustrating an exemplary table for use by the controller depicted by FIG. 2.

### DETAILED DESCRIPTION

The present disclosure generally pertains to water heating systems capable of detecting for dry fire conditions. A water heating system in accordance with one exemplary embodiment of the present disclosure comprises a controller that determines at least one ambient condition, such as ambient temperature, and that then checks for a dry fire condition based on the ambient condition. For example, the controller may dynamically determine a sampling interval for a dry fire test based on the ambient condition. In another example, the controller may dynamically determine a threshold used for sensing a dry fire condition based on the ambient condition. Various other parameters used for testing for a dry fire condition may be based on the ambient condition in other examples.

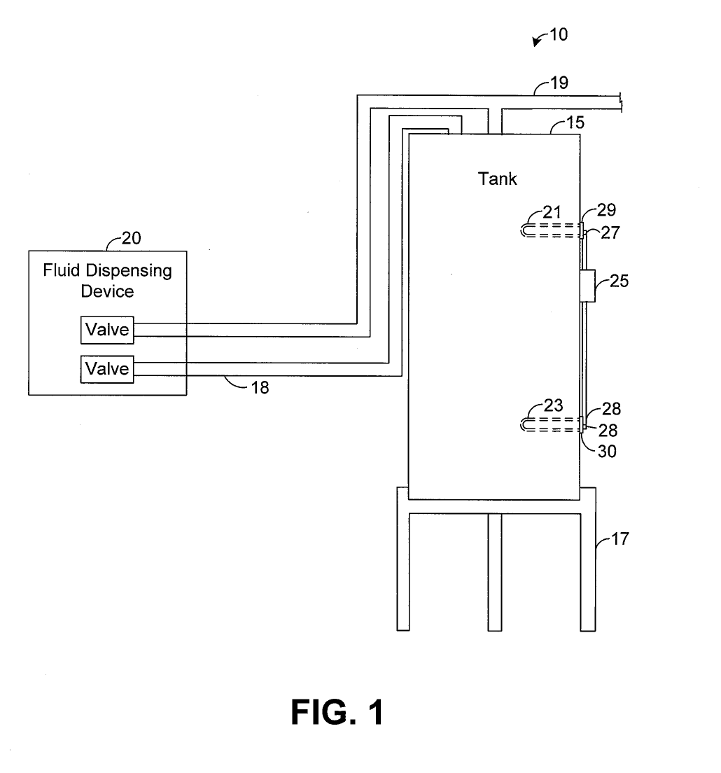

FIG. 1 depicts an exemplary water heating system 10 comprising a tank 15 filled, at least partially, with water. In this regard, water may be drawn from the tank 15 via an outlet pipe 18 and dispensed via a dispensing device 20 coupled to the pipe 18. Further, the water drawn from the tank 15 may be replenished with water from an inlet pipe 19. Note that the water from inlet pipe 19 may be unheated and, therefore, decrease the average temperature of water within the tank 15 when introduced to the tank 15.

In the embodiment shown by FIG. 1, the tank 15 is resting on a stand 17, although such a stand 17 is unnecessary in other embodiments. Two heating elements, an upper heating element 21 and a lower heating element 23, are mounted on the tank 15 and submerged within the water of the tank 15. The heating elements 21 and 23 are selectively controlled by a controller 25 that activates and deactivates the heating elements 21 and 23 based on water temperature, as determined via at least one temperature sensor, which will be described below. In other examples, any number of heating elements may be employed to heat water within the tank 15.

In the exemplary embodiment of FIG. 1, the system 10 comprises a temperature sensor 27, such as a thermistor, that is used for detecting a dry fire condition associated with the upper heating element 21. The temperature sensor 27 is preferably mounted within a close proximity of the upper heating element 21. For example, in one embodiment, an end 29 of the element 21 is exposed, and the sensor 27 is mounted on and contacts the exposed end 29, although other locations of the temperature sensor 27 are possible in other embodiments. Commonly-assigned U.S. Pat. No. 7,099,572, which is incorporated herein by reference, describes exemplary arrangements for mounting the heating element 21 and the sensor 27 used for detecting a dry fire condition for the heating element 21.

In the exemplary embodiment shown by FIG. 1, the system 10 comprises another temperature sensor 28, such as a thermistor, that is used for detecting a dry fire condition associated with the lower heating element 23. The temperature sensor 28 is mounted within a close proximity of the lower heating element 23. For example, in one embodiment, an end 30 of the element 23 is exposed, and the sensor 28 is mounted on and contacts the exposed end 30, although other locations of the temperature sensor 28 are possible in other embodiments.

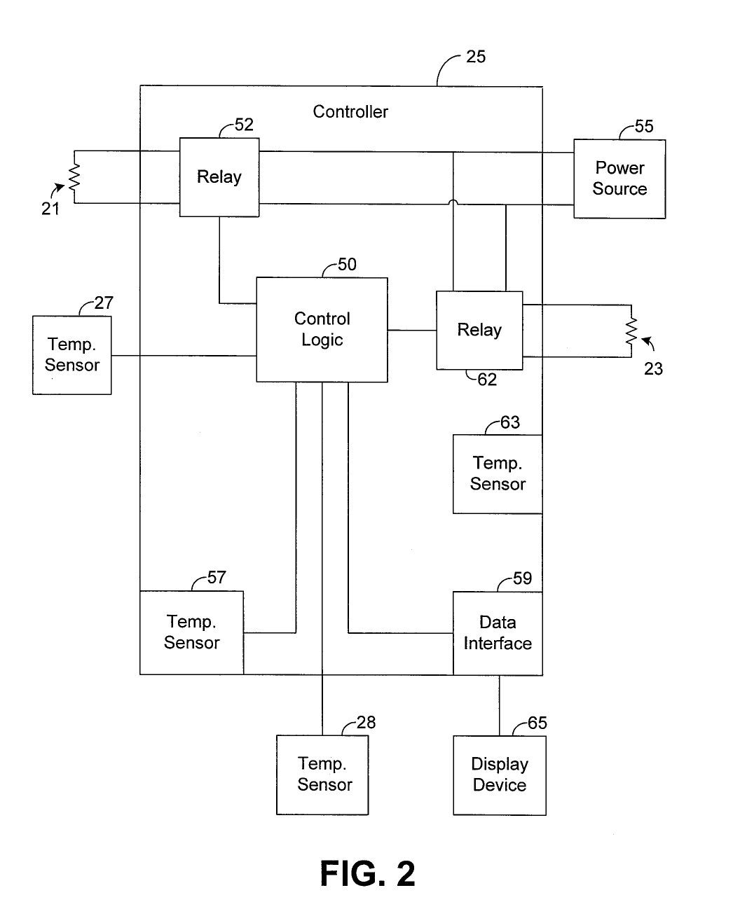

As shown by FIG. 2, the controller 25 has control logic 50, which may be implemented in hardware, software, or a combination thereof. The controller 25 also has a relay 52 that is coupled to a power source 55, as well as the upper heating element 21. In one exemplary embodiment, the heating element 21 is a resistive device that generates heat when electrical current is passed through it. When the upper heating element 21 is to be activated, the control logic 50 closes the relay 52 such that electrical current from the power source 55 is passed through the heating element 21. When the heating element 21 is to be deactivated, the control logic 50 opens the relay 52 such that no current flows through it thereby preventing electrical current from passing through the heating element 21.

The controller 25 further has a relay 62 that is coupled to the power source 55, as well as the lower heating element 23. In one exemplary embodiment, the heating element 23 is a resistive device that generates heat when electrical current is passed through it. When the heating element 23 is to be activated, the control logic 50 closes the relay 62 such that electrical current from the power source 55 is passed through the heating element 23. When the heating element 23 is to be deactivated, the control logic 50 opens the relay 62 such that no current flows through it thereby preventing electrical current from passing through the heating element 23.

The controller 25 comprises a temperature sensor 57 that is in close proximity to and/or contacts the tank 15. Further, the controller 25 and, therefore, the temperature sensor 57 are located close to the heating element 21. In other embodiments, the controller 25 and/or sensor 57 may be located in other areas. The control logic 50 is coupled to the sensor 57 and controls the activation state of the upper heating element 21 based on this sensor 57. For example, if the temperature sensed by the sensor 57 falls below a first temperature threshold, referred to as a “lower set point,” for the element 21, the control logic 50 activates the heating element 21 by closing the relay 52 such that the element 21 heats water within the tank 15. The heating element 21 remains activated until the temperature sensed by the sensor 57 exceeds a second temperature, referred to as an “upper set point,” for the heating element 21. Once the control logic 50 detects that the upper set point has been exceeded, the control logic 50 deactivates the heating element 21 by opening the relay 52.

Using the relay 62, the control logic 50 may control the activation state of the lower heating element 23 based on readings from the temperature sensor 57 in the same or similar way that the control logic 50 controls the activation state of the upper heating element 21 using the relay 52. Alternatively, the system 10 may comprise another temperature sensor (not shown) in close proximity to the lower heating element 23 and in communication with the controller 25. In such an embodiment, control logic 50 may control the activation state of the lower heating element 23 based on such other temperature sensor. The upper and lower set points used to control the lower heating element 23 may the be either the same as or different than the set points used to control the upper heating element 21.

Moreover, based on readings from one or more temperature sensors, the upper and lower heating elements 21 and 23 are repetitively activated and deactivated in an attempt to maintain the temperatures of the water within a desired range. Various other techniques may be used to control the operation of the water heating system 10 and, in particular, the heating elements 21 and 23. Exemplary techniques for controlling components of the water heating system 10 are described in U.S. patent application Ser. No. 11/409,229, entitled “System and Method for Controlling Temperature of a Liquid Residing within a Tank,” and filed on Apr. 21, 2006, which is incorporated herein by reference.

As shown by FIG. 2, the control logic 50 is coupled to a data interface 59 that enables the control logic 50 to exchange information with a user. As an example, the interface 59 may comprise user input devices, such as a keypad, buttons, or switches, that enable a user to input data to the controller 25. The interface 59 may also comprise user output devices, such as a liquid crystal display (LCD) or other display device, light emitting diodes (LEDs), or other components known for outputting or conveying data to a user. The data interface 59 may also comprise communication devices, such as wireless transceivers, that enable the control logic 50 to communicate with external or remote devices.

The control logic 50 is also coupled to a temperature sensor 63, such as a thermistor, for detecting ambient temperature. For example, the sensor 63 may be mounted on a side of the controller 25 opposite of the tank 15 so that the sensor 63 is shielded from the tank 15 by other components of the controller 25 (e.g., a printed circuit board) in an effort to prevent the temperature of the tank 15 from affecting the readings by the sensor 63. Further, the sensor 63 may be exposed such that external air contacts the sensor 63. Other locations of the sensor 63 are possible in other examples. For example, the sensor 63 may be located remotely from the system 10 shown by FIG. 1, and readings from the sensor 63 may be wirelessly or otherwise transmitted to the controller 25.

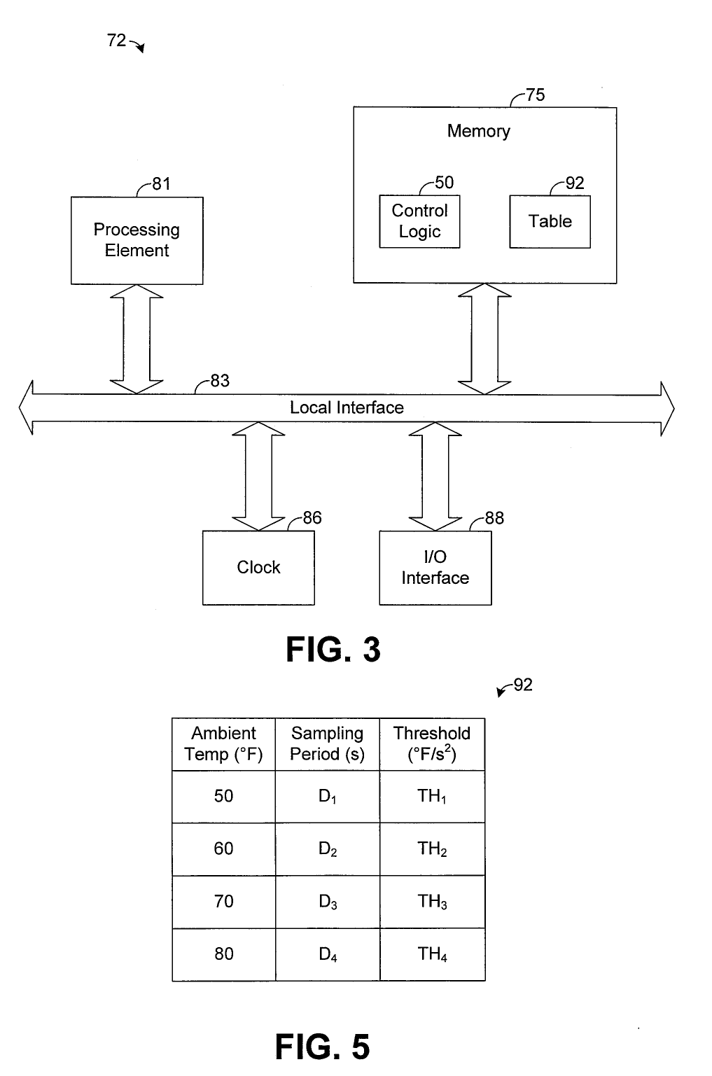

In one exemplary embodiment, the control logic 50 is implemented in software and executed by an instruction execution apparatus, such as the apparatus 72 depicted in FIG. 3. In such an embodiment, the control logic 50 is stored in memory 75.

The exemplary embodiment of the instruction execution apparatus 72 depicted by FIG. 3 comprises at least one conventional processing element 81, such as a digital signal processor (DSP) or a central processing unit (CPU), that communicates to and drives the other elements within the apparatus 72 via a local interface 83, which can include at least one bus. As an example, the processing element 81 fetches and executes the instructions of the control logic 50. Furthermore, a clock 86 may be used to track time, as will be described in more detail hereafter, and an input/output (I/O) interface 88 enables the apparatus 72 to communicate with other components of the system 10. As an example, the I/O interface 88 may be coupled to and enable the control logic 50 to communicate with the relays 52 and 62, the data interface 59, and the temperature sensors 27, 28, 57, and 63.

When the controller 25 is initially activated (e.g., powered-up) the control logic 50 first tests the heating elements 21 and 23 for dry fire conditions. If the dry fire tests are passed (i.e., no detection of a dry fire condition), then the control logic 50 begins controlling the heating elements 21 and 23 based on their respective set points, as described above. However, if either of the elements 21 or 23 fails a dry fire test (i.e., a dry fire condition is detected), then the control logic 50 ensures that the relays 52 and 62 remain in an open state so that the heating elements 21 and 23 remain deactivated until the dry fire condition can be resolved. For example, the control logic 50 may provide an indication via data interface 59 that a dry fire condition has been detected. A user may then investigate the state of the system 10 in an effort to remedy the problem causing the detected dry fire condition. Once the problem has been remedied, the user may provide an input for restarting operation of the controller 25. In response, the control logic 50 may again test for a dry fire condition and then commence with normal operation if no dry fire condition is now detected.

Note that it is unnecessary for each of the heating elements 21 and 23 to be tested for dry fire conditions. In fact, if the heating element 21 is located above the heating element 23, as shown by FIG. 1, then the heating element 23 should be submerged in water if the higher heating element 21 is submerged in water since gravity pulls the water to the bottom of the tank 15. Thus, if there is no dry fire condition associated with element 21, then there should be no dry fire condition associated with element 23. In such an example, testing the heating element 23 for a dry fire condition is unnecessary. Moreover, for simplicity, dry fire tests will be described hereafter as being performed on heating element 21. However, in various embodiments, it is possible for any of the dry fire tests described herein to be performed on any number of heating elements.

There are various techniques that may be used to detect dry fire conditions. In one exemplary embodiment, the heating element 21 is activated for only a very short time period (e.g., about 5 to 10 seconds). In this regard, the control logic 50 closes the relay 52 for about 5 to 10 seconds and then opens relay 52. The duration of the activation time period is selected to be low enough such that the heating element 21 and/or other components of the system 10 will not be damaged by activation of the heating element 21 if it is not submerged in water (i.e., if a dry fire condition exists). After the temporary activation of the heating element 21, the temperature sensor 27 is sampled numerous times by the control logic 50 during a time interval, referred to hereafter as the “sampling period.” In one exemplary embodiment, the duration of the sampling period is selected based on an ambient condition, such as ambient temperature. For example, the control logic 50 may be configured to determine, based on a reading from the temperature sensor 63, the ambient temperature outside of the water heater tank 15. Based on this ambient temperature, the control logic 50 may be configured to determine the duration of the sampling period. In this regard, the rate of temperature change of the heating element 21 during a dry fire condition may be greater if the ambient temperature is lower. Thus, if the ambient temperature is high, the sampling period may be longer as compared to an example for which the detected ambient temperature is lower.

In addition to or in lieu of determining a sampling period based on ambient temperature, a threshold used to detect a dry fire condition can be dynamically determined based on ambient temperature. For example, if the ambient temperature is relatively high, then the control logic 50 may select a threshold that is lower as compared to an example for which the detected ambient temperature is lower.

To enable dynamic selection of the appropriate sampling period duration and/or threshold, a table 92 (FIG. 3) of desired sampling period lengths and/or thresholds for different sensed ambient temperatures or other ambient conditions may be predetermined and stored in the memory 75 of controller 25. Alternatively, the control logic 50 can be configured to calculate the desired sampling period length and/or threshold based on an ambient temperature and/or other ambient conditions detected at run time. By dynamically selecting the sampling period length and/or threshold based on an ambient condition, it may be possible to reduce the overall time needed to accurately detect whether a dry fire condition exists.

In one exemplary embodiment, rate of temperature change is sampled numerous times during the sampling period. In this regard, the control logic 50 determines a first rate of change sample by taking a first reading of the temperature sensor 27 and then taking another reading shortly thereafter. The control logic 50 subtracts the two temperature readings and divides the difference by the time interval between the two readings to yield a rate of change value, which can be stored as a first sample. The control logic 50 repeats this process to determine other rate of temperature change samples. Using such samples, the control logic 50 calculates the rate of change (referred to hereafter as “a_{T}”) in the temperature change rate and compares a_{T} to a threshold, such as the dynamically selected threshold described above, to determine whether a dry fire condition exists. Note that the calculated value, which is compared to the threshold in this embodiment, essentially indicates the temperature acceleration of the heating element 21. In this regard, if R_{T} is the average rate of temperature change during the sampling period, then a_{T} represents the rate at which R_{T} is changing.

To better illustrate the foregoing, assume that two rate of temperature change samples are taken. The first sample is taken during a time interval, t₀, and represents an average rate of temperature change during this time interval. The second sample is taken during a time interval, t₁, after interval t₀ and represents an average rate of temperature change during interval t₁.

In such an example, the control logic 50 can calculate the value, a_{T}, which is indicative of the temperature acceleration from interval t₀ to t₁, according to the following equation:

$${a}_{T} = \frac{{R}_{t 1} - {R}_{t 0}}{{d}_{t 1 - t 0}} \qquad Equation ( 1 )$$

where Rₜ₀ is the rate of temperature change for interval t₀ (i.e., the first sample), Rₜ₁ is the rate of temperature change for interval t₁ (i.e., the second sample), and dₜ₁₋ₜ₀ is the duration from the beginning of t₀ to the end of t₁, assuming that t₁ occurs immediately after t₀. Comparing the measured temperature acceleration, instead of a temperature difference as described in U.S. Pat. No. 6,649,881 B2, to a threshold may enable quicker detection of a dry fire condition. Note that the above example that uses two rate of temperature change samples to calculate temperature acceleration is presented for illustrative purposes, and the calculated temperature acceleration may be based on any number of rate of temperature change samples in other embodiments.

Moreover, if a_{T} does not exceed the threshold, then the control logic 50 determines that a dry fire condition does not exist. In such a case, the control logic 50 begins to control the activation states of the heating elements 21 and 23 based on whether temperatures sensed via at least sensor 57 exceed upper and lower set points for the heating elements 21 and 23. However, if a_{T} exceeds the threshold, then the control logic 50 determines that a dry fire condition exists. In such a case, the control logic 50 deactivates the heating elements 21 and 23 by placing both of the relays 52 and 62 into an open state, and the control logic 50 provides a warning indicating that a dry fire condition exists. For example, the control logic 50 may cause the data interface 59 to display a warning message or illuminate a light source, such as a light emitting diode (LED), to indicate the existence of a dry fire condition.

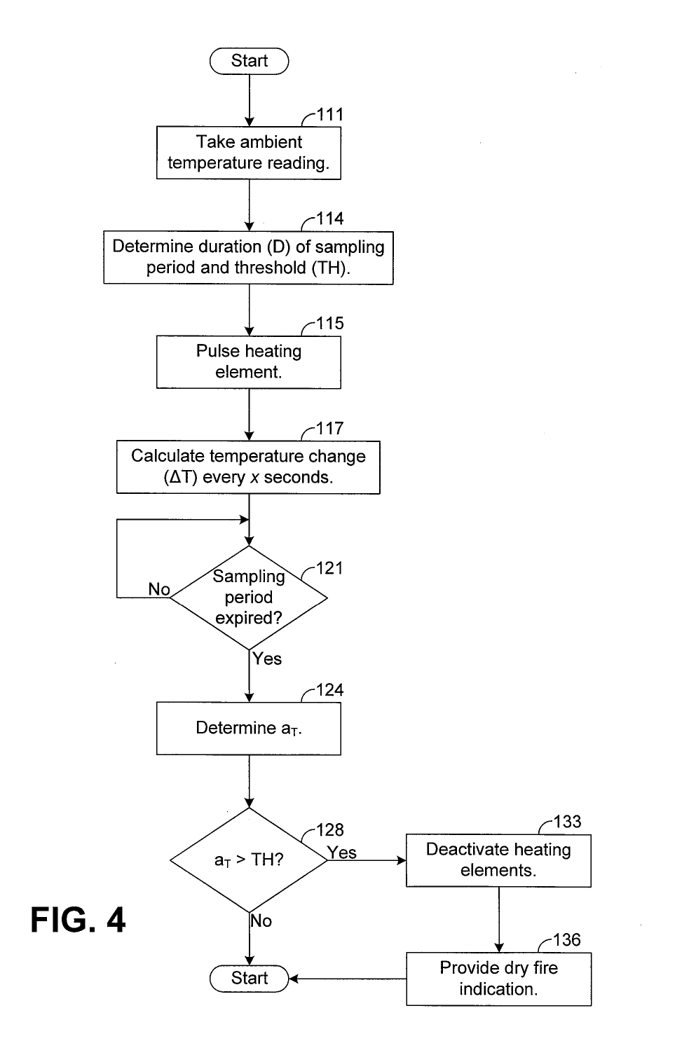

An exemplary use and operation of the system 10 will be described hereafter with particular reference to FIG. 4.

Assume that, as shown by FIG. 5, the table 92 correlates a respective sampling period value and threshold value for each of a plurality of different ambient temperatures. Each sampling period value indicates, for its respective ambient temperature, the sampling period duration to be used for a dry fire test, and each threshold value, for its respective ambient temperature, indicates the threshold to be used for a dry fire test.

Upon power-up, the control logic 50 takes a reading of the temperature sensor 63 to determine ambient temperature, as shown by block 111 of FIG. 4. Based on this ambient temperature, the control logic 50 determines the sampling period duration for a dry fire test to be performed for heating element 21, and the control logic 50 determines the threshold to be used during such dry fire test, as shown by block 114 of FIG. 4. In this regard, assume that the ambient temperature reading is 70 degrees Fahrenheit (F). The control logic 50 accesses the table 92 and determines that a sampling period duration of D₃ seconds (s) and a threshold of Th₃ (degrees F.)/s² are correlated with the measured temperature of 70 degrees F., as shown by FIG. 5. In other examples, if the measured ambient temperature does not match one of the ambient temperatures listed in the table 92, the sampling period duration and the threshold to be used for the dry fire test can be interpolated or otherwise determined from the table 92.

As shown by block 115 of FIG. 4, the control logic 50 begins the dry fire test by pulsing the heating element 21 for a short period, such as about 5 to 10 seconds. In this regard, the control logic 50 closes the relay 52 such that electricity begins flowing through the heating element 21 causing the element 21 to begin emitting heat. After about 5 to 10 seconds, the control logic 50 opens the relay 52 such that electricity stops flowing through the heating element 21. Due to the short activation pulse, the temperature sensed by the sensor 27 should begin to increase. However, if the heating element 21 is submerged in water, then the temperature sensed by the sensor 27 will increase at a rate much lower than if the heating element 21 is not submerged in water (i.e., if a dry fire condition exists).

After the heating element 21 is activated for a short duration, the control logic 50 samples the temperature sensor 27 every x seconds, where x is predefined. For example, the control logic 50 may be configured to sample the temperature sensor 27 every 5 seconds. For each five second time period, the control logic 50 would calculate the change in temperature (ΔT) by subtracting the temperature reading taken at the beginning of the five second period from the temperature reading taken at the end of the same five second period.

The control logic 50 continues sampling the sensor 27 in block 117 for a length of time equal to the sampling period determined from the table 92 in block 114 (i.e., D₃ in the current example). In this regard, the control logic 50 continues sampling in block 117 until the control logic 50 determines in block 121 that the sampling period, as measured from the beginning of block 117, has expired. Thus, from the beginning of block 117 until a “yes” determination in block 121, the control logic 50 calculates n number of ΔT values (i.e., ΔT₁, ΔT₂, ΔT₃, . . . ΔTₙ). For simplicity, assume that n is an even number.

Upon a “yes” determination in block 121, the control logic 50 determines a value, a_{T}, as shown by block 124 of FIG. 4. Such value may be based on any of the samples taken during block 117. In one embodiment, a_{T} is determined by averaging the temperature change rates sensed in the first half of the sampling period and averaging the temperature change rates sensed in the second half of the sampling period. In this regard, the control logic 50 calculates R_{avg1}, which is the average temperature change rate for the first half of the sampling period according to Equation (2) below.
R_{avg1}=(ΔT₁+ΔT₂+ΔT₃+ . . . ΔT_{n/2})/(0.5nx) Equation (2)
where x is the time between each sample, as described above. Further, the control logic 50 calculates R_{avg2}, which is the average temperature change rate for the last half of the sampling period according to Equation (3) below.
R_{avg2}=(ΔT_{(n/2)+1}+ΔT_{(n/2)+2}+ΔT_{(n/2)+3}+ . . . ΔTₙ)/(0.5nx) Equation (3)
Then, the control logic 50 calculates a_{T} according to Equation (4) below.
a_{T}=(R_{avg2}−R_{avg1})/D₃ Equation (4)
where D₃ is the duration of the sampling period being used in the current dry fire test. Note that a_{T} essentially indicates the temperature acceleration sensed by the temperature sensor 27 during the sampling period. In other embodiments, a_{T} may be calculated via other techniques.

After determining a_{T}, the control logic 50 compares a_{T} to the threshold (i.e., TH₃ in the instant example) determined in block 114, as shown by block 128 of FIG. 4. If a_{T} does not exceed TH₃, then the control logic 50 ends the process without providing a dry fire indication. In such a case, the control logic 50 begins normal operation by controlling the activation states of the heating elements 21 and 23 based on upper and lower set points and temperatures sensed by at least sensor 57. However, if a_{T} exceeds TH₃, the control logic 50 deactivates the heating elements 21 and 23 by opening the relays 52 and 62, as shown by block 133 of FIG. 4, and the control logic 50 provides a dry fire indication, as shown by block 136. For example, a warning message may be output via data interface 59. If a dry fire detection is made, then the process shown by FIG. 4 ends without the control logic 50 beginning normal operation. Thus, heating elements 21 and 23 remain deactivated until at least the controller 25 is later re-started such that the process shown by FIG. 4 is repeated.

Note that the techniques described above for sampling the sensor 27 and determining a_{T} are exemplary and other techniques are possible in other examples. For example, in another embodiment, sensor 27 could be sampled at the beginning of the sampling period, at the mid-point of the sampling period, and at the end of the sampling period. In other words, x could be equal to the sampling period duration divided by 2. In such an example, ΔT₁ could be determined by subtracting the readings taken at the beginning and the mid-point of the sampling period, and ΔTₙ could be determined by subtracting the readings taken at the mid-point and the end of the sampling period. In such an example, Equation (2) is reduced to the following equation, assuming that the sampling period duration is equal to D₃.
R_{avg1}=(ΔT₁)/(0.5D₃) Equation (5)
In addition, Equation (3) is reduced to the following equation.
R_{avg2}=(ΔTₙ)/(0.5D₃) Equation (6)
In other embodiments, yet other techniques may be used to determine a_{T}.

Moreover, by dynamically determining parameters of a dry fire test based on an ambient condition, the dry fire test can be more efficiently performed. Accordingly, the time required for completion of the dry fire test may be reduced.

Now, therefore, the following is claimed.

1. A water heating system, comprising:
a tank;
a heating element mounted on the tank;
a first temperature sensor positioned to sense an ambient temperature;
a second temperature sensor positioned to sense a temperature affected by the heating element; and
control logic configured to detect a dry fire condition based on the first and second temperature sensors and to provide an indication of the dry fire condition.

2. The system of claim 1, wherein the control logic is configured to determine a value representing a rate of a temperature change rate sensed by the second temperature sensor, and wherein the control logic is configured to detect the dry fire condition based on the value.

3. The system of claim 1, wherein the control logic is configured to dynamically determine a parameter of a dry fire test based on an ambient temperature sensed by the first temperature sensor and to perform the dry fire test based on a rate of temperature change sensed by the second temperature sensor.

4. The system of claim 1, where in the control logic is configured to determine a duration of a sampling period based on an ambient temperature sensed by the first temperature sensor, the control logic further configured to detect the dry fire condition based on temperatures sensed by the second temperature sensor during the sampling period.

5. The system of claim 1, wherein the control logic is configured to determine a threshold based on an ambient temperature sensed by the first temperature sensor and to detect the dry fire condition based on a comparison of the threshold to a value that is based on at least one temperature sensed by the second temperature sensor.

6. The system of claim 5, wherein the value represents a rate of a temperature change rate.

7. A water heating system, comprising:
a tank;
a heating element mounted on the tank;
a first temperature sensor;
a second temperature sensor positioned to sense a temperature affected by the heating element; and
control logic configured to determine a threshold based on a temperature sensed by the first temperature sensor, the control logic further configured to perform a comparison of the threshold to a value that is based on at least one temperature sensed by the second temperature, the control logic further configured to detect a dry fire condition based on the comparison and to provide an indication of the dry fire condition.

8. The system of claim 7, wherein the value represents a rate of a temperature change rate sensed by the second temperature sensor.

9. The system of claim 7, wherein the first temperature sensor is positioned to sense ambient temperatures.

10. A water heating system, comprising:
a tank;
a heating element mounted on the tank;
a first temperature sensor;
a second temperature sensor positioned to sense a temperature affected by the heating element; and
control logic configured to determine a duration of a sampling period based on a temperature sensed by the first temperature sensor, the control logic further configured to detect a dry fire condition based on temperatures sensed by the second temperature sensor during the sampling period and to provide an indication of the dry fire condition.

11. The system of claim 10, wherein the first temperature sensor is positioned to sense ambient temperatures.

12. The system of claim 10, wherein the control logic is configured to determine a threshold based on a temperature sensed by the first temperature sensor, the control logic further configured to perform a comparison of the threshold to a value that is based on at least one temperature sensed by the second temperature sensor, the control logic further configured to detect the dry fire condition based on the comparison.

13. The system of claim 10, wherein the control logic is configured to determine a value representing a rate of a temperature change rate sensed by the second temperature sensor, and wherein the control logic is configured to detect the dry fire condition based on the value.

14. A method for detecting dry fire conditions in water heating systems, comprising the steps of:
sensing an ambient temperature;
temporarily activating a heating element mounted on a tank of a water heating system;
sensing a plurality of temperatures affected by the activating step;
detecting a dry fire condition based on each of the sensing steps; and
providing an indication of the dry fire condition.

15. The method of claim 14, further comprising the step of determining a value representing a rate of a temperature change rate determined via the sensing the plurality of temperatures step, wherein the detecting step is based on the value.

16. The method of claim 14, further comprising the steps of:
determining a threshold based on the ambient temperature;
comparing the threshold to a value that is based on at least one of the plurality of temperatures,
wherein the detecting step is based on the comparing step.

17. The method of claim 14, further comprising the step of determining a parameter of a dry fire test based on the sensing the ambient temperature step.
